(19) United States
(12) Patent Application Publication
(10) Pub. No.: US 2014/0295925 A1
(43) Pub. Date: Oct. 2, 2014

(54) LEVEL-BALANCING AN ONLINE PROGRESSION GAME

(71) Applicant: Zynga Inc., San Francisco, CA (US)

(72) Inventors: Tobias Morgan Gladwell, Kirkland, WA (US); Douglas Andrew Powers, Bellevue, WA (US); Ramon Recuero Moreno, Seattle, WA (US)

(73) Assignee: ZYNGA INC., SAN FRANCISCO, CA (US)

(21) Appl. No.: 13/932,781

(22) Filed: Jul. 1, 2013

Related U.S. Application Data
(60) Provisional application No. 61/807,015, filed on Apr. 1, 2013.

(51) Int. Cl. A63F 13/00

(52) U.S. Cl. CPC A63F 13/00
USPC 463/9

(57) ABSTRACT

Systems and methods for level-balancing an online progression game, such as by determining a placement order for puzzle games (or, other game challenges) within the progression game, are described. In some example embodiments, the systems and methods access difficulty metrics assigned to puzzle games presented by an online progression game, select a cadence, pattern and/or sequence associated with placing the puzzle games within the online progression game, and place the puzzle games within the online progression game based on matching the accessed difficulty metrics to the selected cadence, pattern, and/or sequence. For example, the systems and methods may determine and/or assign difficulty metrics to puzzle games eligible to be placed within the online progression game by playing each of the puzzle games with an artificial intelligence game play simulator configured to play multiple instances of each of the eligible puzzle games, among other things.

### CLAIM OF PRIORITY

The present application claims the benefit of priority to U.S. Provisional Patent Application Ser. No. 61/807,015, filed Apr. 1, 2013, which is incorporated herein by reference in its entirety.

### FIELD

The present disclosure generally relates to online games and, more specifically, to level-balancing an online progression game.

### BACKGROUND

For many game players, an online game that is too easy to play is boring and unrewarding, and an online game that is too difficult to play is frustrating and similarly unrewarding, and the game players stop playing the game. Therefore, game developers and publishers may utilize various game-balancing and level-balancing techniques in order to tune their online games to the skills of the players of these games.

For example, game developers create an online game, they will often attempt to make the game challenging but ultimately beatable, in order to maintain the interest and attention of players. For example, the difficulty of the game may increase through the play of the game, which may enable players to learn how to play the game while presenting steadily increasing challenges to the players as their skills in playing the game increase over playing time. Typically, game developers will either preselect the difficulty of the game and/or dynamically adjust the game play in an attempt to match the difficulty of the game to the current ability of the players.

### BRIEF DESCRIPTION OF THE DRAWINGS

The example embodiments are illustrated by way of example, and not limitation, in the figures of the accompanying drawings, in which like reference numerals indicate the same or similar elements unless otherwise indicated.

FIG. 1 is a schematic diagram of a virtual gaming system, according to some example embodiments, in which level-balancing of an online progression game is performed.

FIG. 2 is a block diagram of a system, according to some example embodiments, to perform level-balancing of an online progression game.

FIG. 3 is a method, according to some example embodiments, for level-balancing an online progression game.

FIGS. 4A-4C show display diagrams, according to some example embodiments, that depict example curves representative of game play cadences for online progression games.

FIG. 5 is a flowchart depicting a method, according to some example embodiments, for placing puzzles within an online progression game.

FIG. 6 is a schematic diagram, according to some example embodiments, that presents the placement of puzzle games within an online progression game.

FIG. 7 is an interaction diagrams illustrating data flow between example components of the example system of FIG. 1.

FIG. 8 is a diagrammatic representation of an example network environment in which various embodiments may operate.

FIG. 9 is a diagrammatic representation of example computing system architecture, which may be used to implement one or more of the methodologies described herein.

### DESCRIPTION OF EXAMPLE EMBODIMENTS

### Overview

Systems and methods for level-balancing an online progression game, such as by determining a placement order for challenges or quests (e.g., puzzle games) within the progression game, are described. In some example embodiments, the systems and methods access difficulty metrics assigned to puzzle games presented within an online progression game, select a cadence associated with placing the puzzle games within the online progression game, and place the puzzle games within the online progression game based on matching the accessed difficulty metrics to the selected cadence. For example, the systems and methods may determine and/or assign difficulty metrics to puzzle games eligible to be placed within the online progression game by playing each of the puzzle games with an artificial intelligence game play simulator configured to play multiple instances of each of the eligible puzzle games, among other things.

As another example, the systems and methods may perform multiple game play simulations of puzzle games associated with an online progression game, assign difficulty metrics to the puzzle games based on outcomes of the game play simulations, access a curve that represents a preselected cadence associated with placing puzzle games within the online progression game, fit the assigned difficulty metrics to the accessed curve that represents the preselected cadence, determine an order of placement for puzzle games within the online progression game based on a best fit of the assigned difficulty metrics to the accessed curve, and generate the online progression game using the determined order of the placement of the puzzle games.

Thus, in some example embodiments, the systems and methods described herein enable a game publisher to perform level-balancing of an online progression game (e.g., a game that progresses a player as they solve puzzle games presented by the game) by predetermining a optimal or otherwise beneficial order of placing puzzle within the game using artificial intelligence game play simulators and/or other machine learning techniques, among other things.

These level-balancing techniques, which may be performed before a game is presented to a player and/or dynamically performing during the play of a game, enables an online progression game to present puzzles and other challenges that are appropriately tuned to the players of the online progression game, among other things, which may lead to a reduction in player attrition and player enjoyment and satisfaction, among other benefits.

These and other examples are described, by way of example, in further detail below.

### Example System

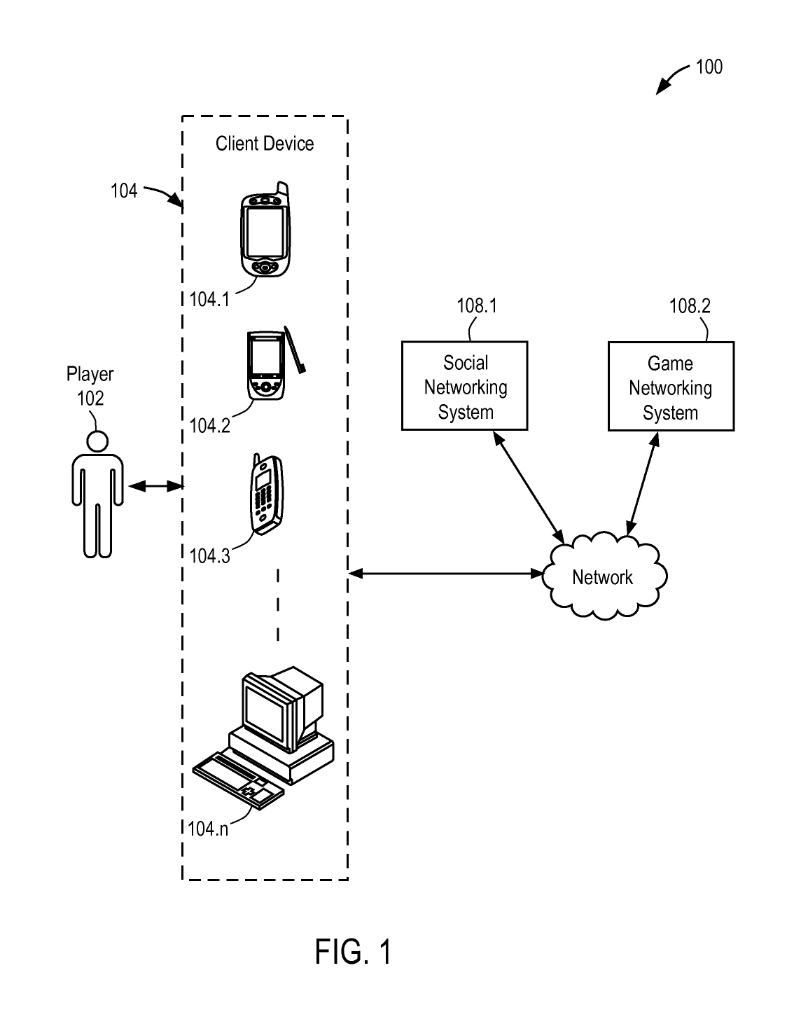

FIG. 1 shows a schematic diagram of a virtual gaming system 100, in accordance with an example embodiment, in which level-balancing of an online progression game is performed. The system 100 may comprise a user device 104 associated with a player 102, a network 106, a social networking system 108.1, and a game networking system 108.2. The example components of the system 100 may be connected directly or via the network 106, which may be any suitable network. In various example embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks.

Although FIG. 1 illustrates a particular example of the arrangement of the player 102, the user device 104, the social networking system 108.1, the game networking system 108.2, and the network 106, this disclosure includes any suitable arrangement or configuration of the player 102, the user device 104, the social networking system 108.1, the game networking system 108.2, and the network 106.

The user device 104 may be any suitable computing device (e.g., devices 104.1-104.n), such as a smart phone 104.1, a personal digital assistant (PDA) 104.2, a mobile phone 104.3, a personal computer 104.n, a laptop, a computing tablet, a gaming device, or any other device suitable for playing a virtual game. The user device 104 may access the social networking system 108.1 or the game networking system 108.2 directly, via the network 106, or via a third-party system. For example, the user device 104 may access the game networking system 108.2 via the social networking system 108.1. It should be noted that the functionality described herein may reside partially or wholly on any one device or be distributed across several devices.

The social networking system 108.1 may include a network-addressable computing system that can host one or more social graphs and may be accessed by the other components of the system 100 either directly or via the network 106. The social networking system 108.1 may generate, store, receive, and transmit social networking data, among other things.

As described herein, the game networking system 108.2 may support a variety of different types of games, including online progression games. An online progression game may be any game that presents puzzles and/or other challenges to a player at various levels within the game, and enables the player to progress through the game when the puzzles and/or other challenges are successfully completed by the player.

For example, the online progression game may provide a path from a starting point within the game to an endpoint or intermediate points within the game, and enable the player to move between the points after the player successfully completes puzzles, challenges, tasks, and other level-based actions.

Puzzle games and other games encountered by a player within the online progression game may vary in the type of game, difficulty level, completion or success criteria, and so on. Puzzle games are generally based on logical or conceptual game play challenges, and may be timed or include other applied constraints. Thus, a puzzle may be successfully completed when a player solves a puzzle, such as a puzzles associated with pattern recognition, process understanding, and other constructs. In solving or otherwise completing puzzles, a player may manipulate various game pieces or perform other game actions. Example puzzle games presented by the online progression games include action or arcade games, hidden object games, physics games, tile matching games, and so on.

### Examples of Level-Balancing Online Progression Games

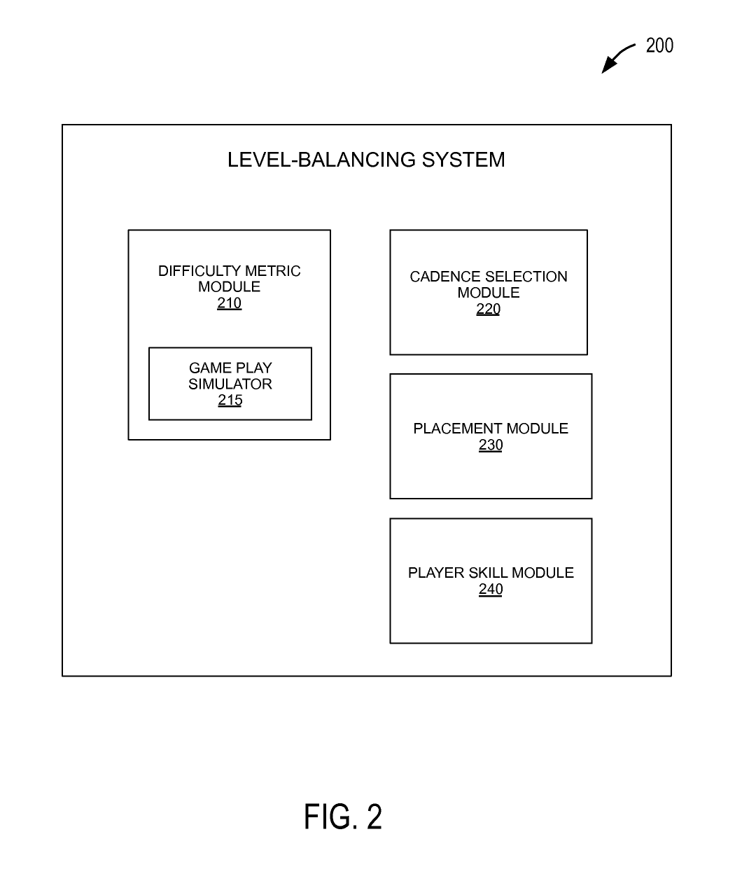

In some example embodiments, in order to performing level-balancing or otherwise determine the order of levels within online progression games provided and/or supported by the game networking system 108.2, the game networking system 108.2 may utilize a level-balancing system. FIG. 2 shows a block diagram of the level-balancing system 200, according to some example embodiments, to perform level-balancing of an online progression game. An online progression game may be an online game where a game fiction presents levels of varying difficulty to players of the online game. For example, the game fiction may include and/or follow a cadence associated with the difficulty of game levels presented to a player, the cadence representing a pattern or path of difficulty, among other things.

The level-balancing system 200 includes a difficulty metric module 210, which includes and/or communicates with an artificial intelligence game play simulator 215, a cadence selection module 220, a placement module 230, and a player skill module 240.

As illustrated in FIG. 2, the level-balancing system 200 includes a variety of functional modules. One skilled in the art will appreciate that the functional modules are implemented with a combination of software (e.g., executable instructions, or computer code) and hardware (e.g., at least a memory and processor). Accordingly, as used herein, in some embodiments a module is a processor-implemented module and represents a computing device having a processor that is at least temporarily configured and/or programmed by executable instructions stored in memory to perform one or more of the particular functions that are described herein.

In some example embodiments, the difficulty metric module 210 is configured and/or programmed to access difficulty metrics assigned to puzzle games (or other challenges) presented within an online progression game. For example, the difficulty metric module 210 may access, obtain, retrieve, and/or receive difficulty metrics that are associated with puzzle games eligible to be placed within the online progression game.

The artificial intelligence (AI) game play simulator 215 may, in some example embodiments, generate, create, and/or determine the difficulty metrics to be assigned to the eligible puzzle games. Using artificial intelligence, the AI game play simulator 215 is configured to play the puzzle games in a variety of ways, such as under various game play contraints, using various player skill levels, and so on. The AI game play simulator 215, therefore, may play multiple instances of each of the puzzle games in order to determine the difficulty metrics assigned to the puzzle games presented within the online progression game.

The AI game play simulator 215 may be scripted in order to communicate with and play the puzzle games of the online progression game. For example, the AI game play simulator 215 may be part of the game client (e.g., the game networking system 108.2), and generated in a language (e.g., ActionScript, HTML5, JavaScript) that is compatible with the puzzle games, among other things.

For example, the AI game play simulator 215 may play one or more instances of each of the puzzle games using a constraint associated with optimizing a game play path (e.g., a number or sequence of moves within the puzzle game) to successfully complete each of the puzzle games, using a constraint associated with optimizing a game play time to successfully complete each of the puzzle games, using a constraint associated with optimizing a game play score for successfully completing each of the puzzle games, and so on.

In some example embodiments, the AI game play simulator 215 may be tuned and/or configured to play puzzle games while simulating various different skill levels, such as beginner or new player skill levels, intermediate skill levels, advanced skill levels, expert skill levels, and so on, and/or various player types, such as distracted players, completionist players, methodical players, and so on.

For example, when determining a difficulty metric for a given puzzle game, the AI game play simulator may play many (e.g., 100,000 or more) instances or interations of the puzzle game at a beginner skill level, and many instances or interations of the puzzle game at an intermediate or advanced skill level. The AI game play simulator 215, or other components associated with the difficulty metric module 210, may perform various statistical analyses, such as applying various criteria, in order to determine, calculate, and/or select a difficulty metric for the puzzle game that is based on outcomes of the many played instances, such as outcomes associated with a duration of playing the puzzle game, a score achieved while playing the puzzle game, and so on.

For example, the difficulty metric module 210 may assign a number between 1 and 10 to each puzzle game, according to a determined difficulty associated with successfully completing the puzzle game. Of course, the difficulty metric module 210 may assign other values to a puzzle game that represent the difficulty of the puzzle game, such as other single values, multiple values, vectors, and so on.

In some example embodiments, the cadence selection module 220 is configured and/or programmed to select a cadence associated with placing the puzzle games within the online progression game. For example, the cadence selection module 220 may select a cadence, such as a pattern or sequence that identifies and/or represents an order of placement of puzzle games within the online progression game, such as a placement of puzzle games at various levels within the online progression game. For example, a cadence may represent a sequence via which levels are presented to a player, the sequence based on an assigned and/or determined difficulty for the levels.

In some example embodiments, a curve, line, and/or other two- or three-dimensional geometric objects may represent the selected cadence. For example, a sawtooth curve, a parabolic curve, a straight line, and/or other curves and/or lines in geometric space may represent a cadence associated with changing difficulty levels for puzzle games as a player progresses through the online progression game, among other things.

In some example embodiments, the placement module 230 is configured and/or programmed to place the puzzle games within the online progression game based on matching the accessed difficulty metrics to the selected cadence. For example, the placement module 230 may determine an order and/or ranking for each of the puzzle games based on a match of difficulty metrics assigned to the puzzle games with a curve that represents the selected cadence.

The placement module 230 may perform various curve fitting techniques in order to match the difficulty metrics to the curve representing the selected cadence, such as techniques that determine a best fit for the difficulty metrics to the curve, among other things. For example, the placement module 230 may identify and/or determine a curve, represented by a mathematical function (e.g., an algebraic or geometric function), that fits (e.g., is a “best” or suitable fit) for a group of data points associated with the difficulty metrics.

For example, the placement module 230 may consider a complete set of puzzle games (e.g., 100 or more puzzle games) eligible to be placed within an online progression game that requires 20 puzzle games, and place a subset of the puzzle games that best fit a geometric curve (e.g., a sawtooth curve) representing the cadence for the online progression game.

Thus, the placement module 230 may fit the difficulty metrics assigned to the puzzle games to a curve that represents the selected cadence, select a subset of puzzle games from a set of puzzle games eligible to be placed within the online progression game by determining a best fit of the difficulty metrics to the curve that represents the selected cadence, and place the selected subset of puzzle games within the online progression game based on the determined best fit of the difficulty metrics to the curve that represents the selected cadence.

In some example embodiments, the player skill module 240 is configured and/or programmed to determine a skill level for a player of the online progression game. For example, the player skill module 240 may identify a player of the online progression game as a certain skilled player (e.g., beginner, intermediate, advanced) based on demographic player associated with the player, current game play statistics, and so on. The level-balancing system 200 may utilize information associated with a skill level for a player in order to dynamically adjust and/or modify the placement of puzzle games and other levels during game play (e.g., between chapters of a currently playing online game). For example, the placement module 230 may be configured to place the puzzle games within the online progression game based on matching the accessed difficulty metrics to the selected cadence and based on the determined skill level for the player of the online game.

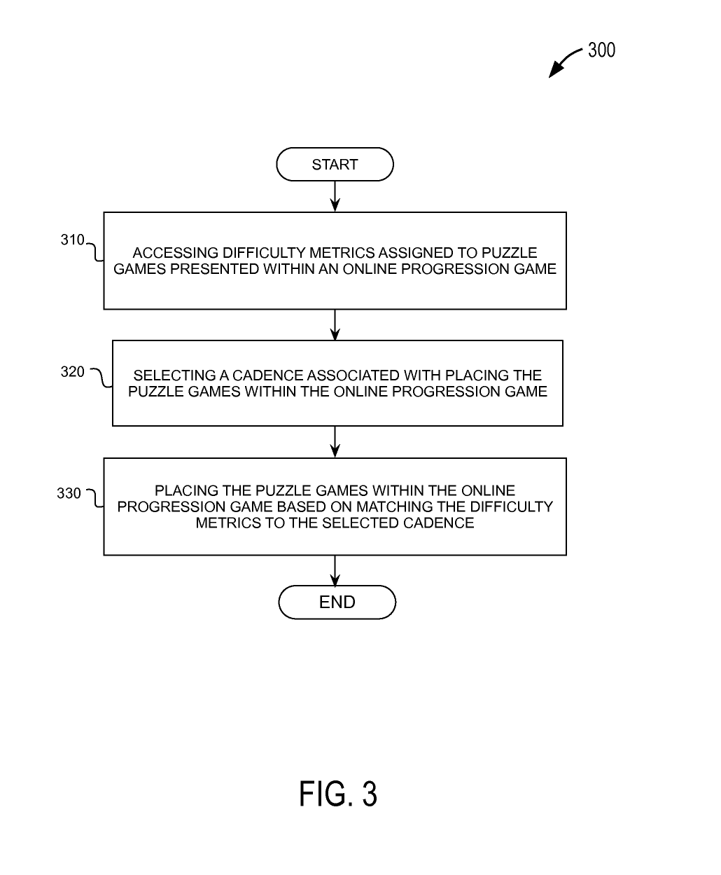

As described herein, in some example embodiments, the level-balancing system 200 utilizes artificial intelligence to predetermine difficulty metrics or levels associated with puzzle games that are eligible to be placed within an online progression game, and places, or level-balances, the puzzle games based on the difficulty metrics, among other things. FIG. 3 shows a method 300, according to some example embodiments, for level-balancing an online progression game. The method 300 may be performed by the level-balancing system 300 and, accordingly, is described herein merely by way of reference thereto. It will be appreciated that the method 300 may be performed on any suitable hardware.

In operation 310, the level-balancing system 200 accesses difficulty metrics assigned to puzzle games presented within an online progression game. For example, the difficulty metric module 210 may access difficulty metrics determined by the artificial intelligence game play simulator 215.

For example, the AI game play simulator 215 may determine a difficulty metric for a puzzle game by playing multiple instances of each of the puzzle games using a playing constraint to optimize a game play path when successfully completing each of the puzzle games, by playing multiple instances of each of the puzzle games using a playing constraint to optimize a game play time when successfully completing each of the puzzle games, by playing multiple instances of each of the puzzle games using a playing constraint to optimize a game play score when successfully completing each of the puzzle games, by playing multiple instances of each of the puzzle games using a playing constraint of playing each of the puzzle games as an unskilled player of the online progression game, by playing multiple instances of each of the puzzle games using a playing constraint of playing each of the puzzle games as a skilled player of the online progression game, and so on.

Thus, in some example embodiments, the difficulty metric module 210 may access difficulty metrics generated by artificial intelligence configured to perform the multiple game play simulations under one or more game play constraints associated with optimizing successful completion of the puzzle games.

In operation 320, the level-balancing system 200 selects a cadence associated with placing the puzzle games within the online progression game. For example, the cadence selection module 220 may select a cadence, such as a pattern or sequence, which identifies an order of placement of puzzle games within the online progression game, such as a placement of puzzle games at various levels within the online progression game.

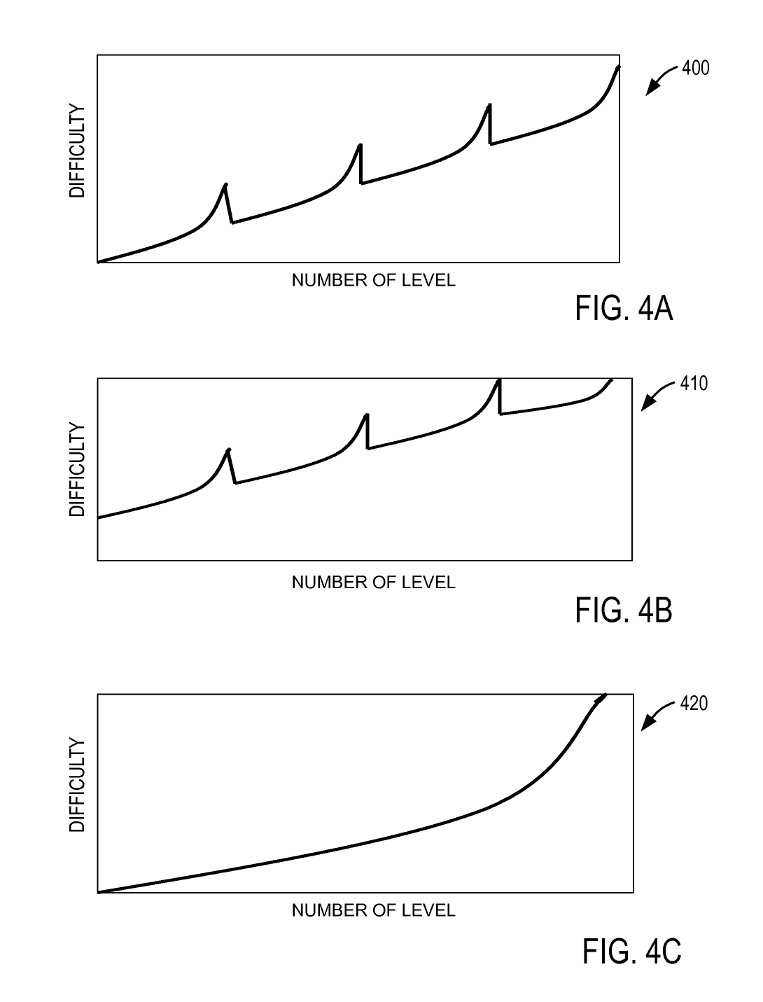

As described herein, in some example embodiments, a geometric curve may represent the selected cadence. FIGS. 4A-4C show display diagrams, according to some example embodiments, that depict example curves representative of game play cadences for online progression games.

For example, FIG. 4A depicts a sawtooth curve that represents a certain game play cadence for an online progression game, with the x-axis representing the number of the level within the online progression game, and the y-axis representing the difficulty assigned to the level. The sawtooth curve may represent progression between chapters or other segments within a game fiction of an online progression game.

As another example, FIG. 4B depicts a sawtooth curve that represents the certain game play cadence for the online progression game being adjusted for the skill of the player of the online progression game. As shown in FIG. 4B, the curve is moved up along the y-axis, because the level-balancing system 200 (e.g., via the player skill module 240) determines the player is a skilled player, and adjusts the cadence to increase the difficulty of the levels within the online progression game.

As another example, FIG. 4C depicts a parabolic curve that represents a certain game play cadence for a chapter or other segment of the online progression game. Of course, the level-balancing system 200 may utilize other curves as representatives of game play cadences, such as other two-dimensional curves, three-dimensional curves, and so on.

Referring back to FIG. 3, in operation 330, the level-balancing system 200 presents and/or places the puzzle games within the online progression game based on matching the difficulty metrics to the selected cadence. For example, the placement module 230 may place the puzzle games within a game play path of the online progression game by best fitting the difficulty metrics assigned to the puzzles to a curve that represents the selected cadence, such as the curves depicted in FIGS. 4A-4C, among others.

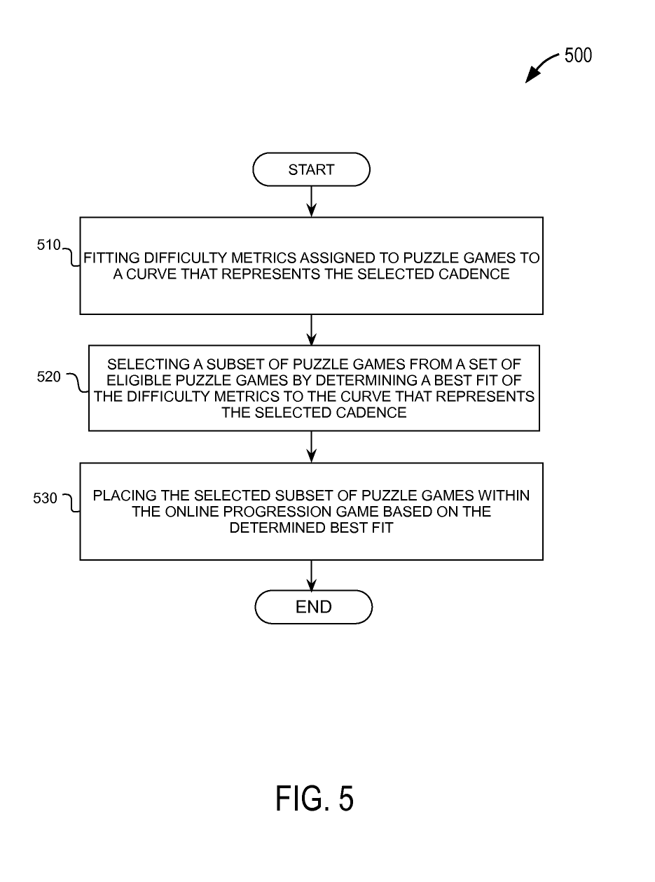

As described herein, in some example embodiments, the placement module 230 may place a subset or smaller group of puzzle games from a set or larger group of puzzle games eligible to be placed within the online progression game. FIG. 5 shows a method 500, according to some example embodiments, for placing puzzles within an online progression game. The method 500 may be performed by the placement module 230 and, accordingly, is described herein merely by way of reference thereto. It will be appreciated that the method 500 may be performed on any suitable hardware.

In operation 510, the placement module 230 fits the difficulty metrics assigned to the puzzle games to a curve that represents the selected cadence. In operation 520, the placement module 230 selects a subset of puzzle games from a set of puzzle games eligible to be placed within the online progression game by determining a best fit of the difficulty metrics to the curve that represents the selected cadence. In operation 530, the placement module 230 places the selected subset of puzzle games within the online progression game based on the determined best fit of the difficulty metrics to the curve that represents the selected cadence. Thus, in some example embodiments, the placement module 230 may utilize difficulty metrics assigned to puzzle games to select a group of puzzle games that best fit a curve representing a desired cadence for the online progression game, among other things.

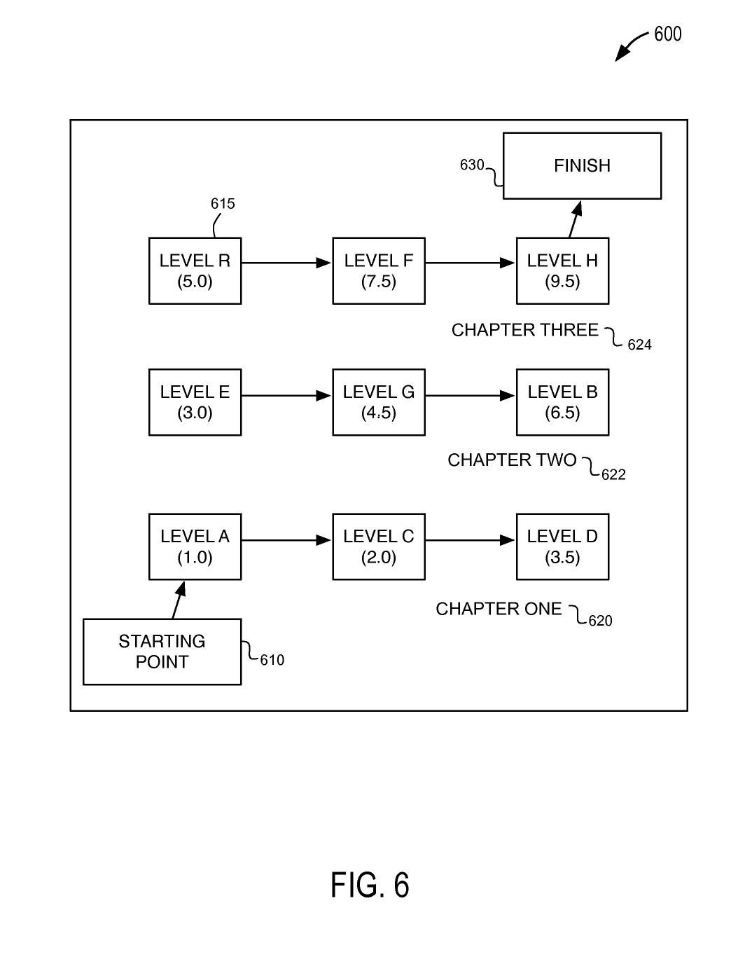

As described herein, in some example embodiments, the level-balancing system 200 may generate various orders of puzzle games for a given online progression game. FIG. 6 shows a schematic diagram 600, according to some example embodiments, that presents the placement of puzzle games within an online progression game.

The online progression game may include a starting point 610 and an finish point 630, and various puzzle games placed in an order within the online progression that is determined by the level-balancing system 200. For example, “Chapter One” 620 of the game includes puzzle games “Level A,” “Level C” and “Level D,” which have been assigned difficulty metrics of 1.0, 2.0, and 3.5, respectively, by the AI game play simulator 215, “Chapter Two” 622 of the game includes puzzle games “Level E,” “Level G” and “Level B,” which have been assigned difficulty metrics of 3.0, 4.5, and 6.5, respectively, by the AI game play simulator 215, and “Chapter Three” 624 of the game includes puzzle games “Level R,” “Level F” and “Level H,” which have been assigned difficulty metrics of 5.0, 7.5, and 9.5, respectively, by the AI game play simulator 215.

Following the example, the level-balancing system 200 selects cadence 500 of FIG. 5A, which is a sawtooth cadence, and places the puzzle games 615 within the online progression game based on matching their assigned difficulty metrics (e.g., 1.0, 2.0, and 3.5 for Chapter One, 3.0, 4.5, and 6.5 for Chapter Two, and 5.0, 7.5, and 9.5 for Chapter Three) to the sawtooth cadence 500.

Thus, in some example embodiments, the systems and methods described herein may perform multiple game play simulations of puzzle games associated with an online progression game, assign difficulty metrics to the puzzle games based on outcomes of the game play simulations, access a curve that represents a preselected cadence associated with placing puzzle games within the online progression game, fit the assigned difficulty metrics to the accessed curve that represents the preselected cadence, determine an order of placement for puzzle games within the online progression game based on a best fit of the assigned difficulty metrics to the accessed curve, and generate the online progression game using the determined order of the placement of the puzzle games, such as the order shown in FIG. 6.

### Example Game Systems, Social Networks, and Social Graphs

As described herein, the example systems described herein may include, communicate, or otherwise interact with a game system. As such, a game system is now described to illustrate further example embodiments. In an online multiuser game, users control player characters (PCs), a game engine controls non-player characters (NPCs); the game engine also manages player character state and tracks states for currently active (e.g., online) users and currently inactive (e.g., offline) users. A game engine, in some example embodiments, may include a documentation engine. Alternatively, the documentation engine and game engine may be embodied as separate components operated by the game network system and/or the document provision system.

A player character may have a set of attributes and a set of friends associated with the player character. As used herein, the terms “state” and “attribute” can be used interchangeably to refer to any in-game characteristic of a player character, such as location, assets (e.g., value icons), levels, condition, health, status, inventory, skill set, name, orientation, affiliation, specialty, and so on. The game engine may use a player character state to determine the outcome of a game event, while sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights, and/or benefits, or the obtaining of some assets (e.g., health, money (e.g., virtual currency from a value icon), strength, inventory, land, etc.). A game engine may determine the outcome of a game event according to game rules (e.g., “a character with less than 5 health points will be prevented from initiating an attack”), based on a character's state, and also possibly on interactions of other player characters and a random calculation. Moreover, an engagement may include simple tasks (e.g., cross the river, shoot at an opponent, interact with a value icon, or the like), complex tasks (e.g., win a battle, unlock or solve a puzzle, build a factory, rob a liquor store), or other events, such as events or levels within an online progression game.

Referring back to FIG. 1, a virtual game, such as an online progression game, may be hosted by the game networking system 108.2, which can be accessed using any suitable connection with a suitable user device 104. A user may have a game account on the game networking system 108.2, wherein the game account may contain a variety of information associated with the user (e.g., the user's personal information, financial information, purchase history (e.g., of in-game assets), player character state, game state, or any other user profile data). In some embodiments, a user may play multiple games on the game networking system 108.2, which may maintain a single game account for the user with respect to the multiple games, or multiple individual game accounts for each game with respect to the user. In some embodiments, the game networking system 108.2 may assign a unique identifier to a player 102 of a virtual game hosted on the game networking system 108.2. The game networking system 108.2 may determine that the player 102 is accessing the virtual game by reading the user's cookies, which may be appended to HTTP requests transmitted by the user device 104, and/or by the player 102 logging onto the virtual game.

In some example embodiments, the player 102 accesses a virtual game and controls the game's progress via the user device 104 (e.g., by inputting commands to the game at the user device 104). The user device 104 can display the game interface, receive inputs from the player 102, transmit user inputs or other events to the game engine, and receive instructions from the game engine. The game engine can be executed on any suitable system (such as, for example, the user device 104, the social networking system 108.1, or the game networking system 108.2). For example, the user device 104 may download client components of a virtual game, which are executed locally, while a remote game server, such as the game networking system 108.2, provides backend support for the client components and may be responsible for maintaining application data of the game, processing the inputs from the player 102, updating and/or synchronizing the game state based on the game logic and each input from the player 102, and transmitting instructions to the user device 104. As another example, when the player 102 provides an input to the game through the user device 104 (such as, for example, by typing on the keyboard, clicking the mouse, or interacting with a touch screen of the user device 104), the client components of the game may transmit the user's input to the game networking system 108.2.

In some example embodiments, the player 102 accesses particular game instances of a virtual game. A game instance is a copy of a specific game play area that is created during runtime. In some embodiments, a game instance is a discrete game play area where one or more players 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some example embodiments, a game engine interfaces with a social graph. Social graphs are models of connections between entities (e.g., individuals, users, contacts, friends, users, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a user or player character in an online multiuser game.

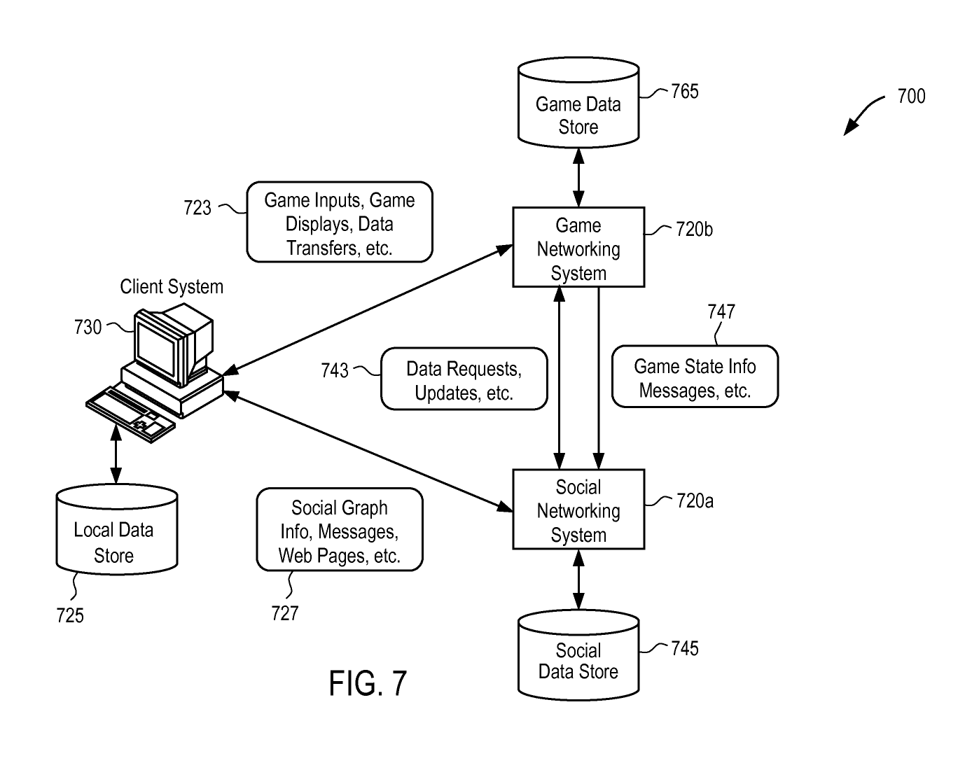

FIG. 7 shows an example data flow between example components of an example system 700. One or more of the components of the example system 700 may correspond to one or more of the components of the example system 100. In some embodiments, system 700 includes a client system 730, a social networking system 720a, and a game networking system 720b. The components of system 700 can be connected to each other in any suitable configuration, using any suitable type of connection. The components may be connected directly or over any suitable network. The client system 730, the social networking system 720a, and the game networking system 720b may have one or more corresponding data stores, such as the local data store 725, the social data store 745, and the game data store 765, respectively.

The client system 730 may receive and transmit data 723 to and from the game networking system 720b. This data can include, for example, a web page, a message, a game input, a game display, a HTTP packet, a data request, transaction information, and other suitable data. At some other time, or at the same time, the game networking system 720b may communicate data 743, 747 (e.g., game state information, game system account information, page info, messages, data requests, updates, etc.) with other networking systems, such as the social networking system 720a (e.g., Facebook, Myspace, etc.). The client system 730 can also receive and transmit data 727 to and from the social networking system 720a. This data can include, for example, web pages, messages, social graph information, social network displays, HTTP packets, data requests, transaction information, updates, and other suitable data.

Communication between the client system 730, the social networking system 720a, and the game networking system 720b can occur over any appropriate electronic communication medium or network using any suitable communication protocol. For example, the client system 730, as well as various servers of the systems described herein, may include Transport Control Protocol/Internet Protocol (TCP/IP) networking stacks to provide for datagram and transport functions. Of course, any other suitable network and transport layer protocols can be utilized.

In some example embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses a virtual game on the game networking system 720b, the BLOB containing the game state for the instance corresponding to the user may be transmitted to the client system 730 for use by a client-side executed object to process. In some embodiments, the client-side executable is a FLASH-based game, which can de-serialize the game state data in the BLOB. As a user plays the game, the game logic implemented at the client system 730 maintains and modifies the various game state parameters locally. The client-side game logic may also batch game events, such as mouse clicks, and transmit these events to the game networking system 720b. Game networking system 720b may itself operate by retrieving a copy of the BLOB from a database or an intermediate memory cache (memcache) layer. The game networking system 720b can also de-serialize the BLOB to resolve the game state parameters and execute its own game logic based on the events in the batch file of events transmitted by the client to synchronize the game state on the server side. The game networking system 720b may then re-serialize the game state, now modified into a BLOB, and pass this to a memory cache layer for lazy updates to a persistent database.

In some example embodiments, a computer-implemented game is a text-based or turn-based game implemented as a series of web pages that are generated after a user selects one or more actions to perform. The web pages may be displayed in a browser client executed on the client system 730. For example, a client application downloaded to the client system 730 may operate to serve a set of web pages to a user. As another example, a virtual game may be an animated or rendered game executable as a stand-alone application or within the context of a webpage or other structured document. In some embodiments, the virtual game is implemented using Adobe Flash-based technologies. As an example, a game may be fully or partially implemented as a SWF object that is embedded in a web page and executable by a Flash media user plug-in. In some embodiments, one or more described web pages are associated with or accessed by the social networking system 720a. This disclosure contemplates using any suitable application for the retrieval and rendering of structured documents hosted by any suitable network-addressable resource or website.

Application event data of a game is any data relevant to the game (e.g., user inputs or interations). In some embodiments, each application datum may have a name and a value, and the value of the application datum may change (e.g., be updated) at any time. When an update to an application datum occurs at the client system 730, either caused by an action of a game user or by the game logic itself, the client system 730 may need to inform the game networking system 720b of the update. For example, if the game is a farming game with a harvest mechanic (such as FarmVille by Zynga), an event can correspond to a user clicking on a parcel of land to harvest a crop. In such an instance, the application event data may identify an event or action and an object in the game to which the event or action applies.

In some example embodiments, one or more objects of a game are represented as an Adobe Flash object. Flash may manipulate vector and raster graphics, and supports bidirectional streaming of audio and video. “Flash” may mean the authoring environment, the user, or the application files. In some embodiments, the client system 730 may include a Flash client. The Flash client may be configured to receive and run a Flash application or game object code from any suitable networking system (such as, for example, the social networking system 720a or the game networking system 720b). In some embodiments, the Flash client is run in a browser client executed on the client system 730. A user can interact with Flash objects using the client system 730 and the Flash client. The Flash objects can represent a variety of in-game objects. Thus, the user may perform various in-game actions on various in-game objects by making various changes and updates to the associated Flash objects.

In some example embodiments, in-game actions are initiated by clicking or similarly interacting with a Flash object that represents a particular in-game object. For example, a user can interact with a Flash object to use, move, rotate, delete, scratch, attack, shoot, redeem virtual currency from a value object, or harvest an in-game object. This disclosure contemplates performing any suitable in-game action by interacting with any suitable Flash object. In some embodiments, when the user makes a change to a Flash object representing an in-game object, the client-executed game logic may update one or more game state parameters associated with the in-game object. To ensure synchronization between the Flash object shown to the user and the client system 730, the Flash client may send the events that caused the game state changes to the in-game object to the game networking system 720b. However, to expedite the processing and, hence, the speed of the overall gaming experience, the Flash client may collect a batch of some number of events or updates into a batch file. The number of events or updates may be determined by the Flash client dynamically or determined by the game networking system 720b based on server loads or other factors. For example, client system 730 may send a batch file to the game networking system 720b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to user data or metadata, changes to user social connections or contacts, user inputs to the game, and events generated by the game logic. The user profile data may include application event data. In some embodiments, each application datum has a name and a value. The value of an application datum may change at any time in response to the game play of a user or in response to the game engine (e.g., based on the game logic). In some embodiments, an application data update occurs when the value of a specific application datum is changed.

In some example embodiments, when a user plays a virtual game on the client system 730, the game networking system 720b serializes all the game-related data, including, for example and without limitation, game states, game events, and user inputs, for this particular user and this particular game into a BLOB and may store the BLOB in a database. The BLOB may be associated with an identifier that indicates that the BLOB contains the serialized game-related data for a particular user and a particular virtual game. In some embodiments, while a user is not playing the virtual game, the corresponding BLOB may be stored in the database. This enables a user to stop playing the game at any time without losing the current state of the game the user is in. When a user resumes playing the game next time, game networking system 720b may retrieve the corresponding BLOB from the database to determine the most-recent values of the game-related data. In some embodiments, while a user is playing the virtual game, the game networking system 720b also loads the corresponding BLOB into a memory cache so that the game system may have faster access to the BLOB and the game-related data contained therein.

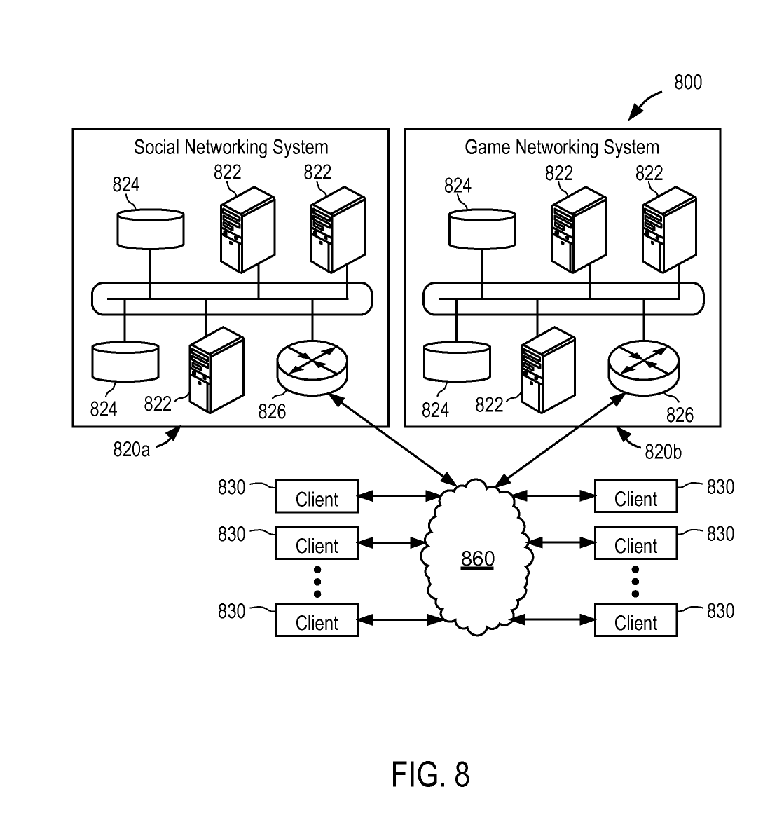

Various example embodiments may operate in a WAN environment, such as the Internet, including multiple network addressable systems. FIG. 8 shows an example network environment 800, in which various example embodiments may operate. A network cloud 860 generally represents one or more interconnected networks, over which the systems and hosts described herein can communicate. Network cloud 860 may include packet-based WANs (such as the Internet), private networks, wireless networks, satellite networks, cellular networks, paging networks, and the like. As FIG. 8 illustrates, various example embodiments may operate in a network environment 800 comprising one or more networking systems, such as a social networking system 820a, a game networking system 820b, and one or more client systems 830. The components of the social networking system 820a and the game networking system 820b operate analogously; as such, hereinafter they may be referred to simply as the networking system 820. The client systems 830 are operably connected to the network cloud 860 via a network service provider, a wireless carrier, or any other suitable means.

The networking system 820 is a network addressable system that, in various example embodiments, comprises one or more physical servers 822 and data stores 824. The one or more physical servers 822 are operably connected to computer network cloud 860 via, by way of example, a set of routers and/or networking switches 826. In an example embodiment, the functionality hosted by the one or more physical servers 822 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

The physical servers 822 may host functionality directed to the operations of the networking system 820. Hereinafter servers 822 may be referred to as server 822, although the server 822 may include numerous servers hosting, for example, the networking system 820, as well as other content distribution servers, data stores, and databases. Data store 824 may store content and data relating to, and enabling operation of, the networking system 820 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like.

Logically, data store 824 corresponds to one or more of a variety of separate and integrated databases, such as relational databases and object-oriented databases, that maintain information as an integrated collection of logically related records or files stored on one or more physical systems. Structurally, data store 824 may generally include one or more of a large class of data storage and management systems. In some embodiments, data store 824 may be implemented by any suitable physical system(s) including components, such as one or more database servers, mass storage media, media library systems, storage area networks, data storage clouds, and the like. In one example embodiment, data store 824 includes one or more servers, databases (e.g., MySQL), and/or data warehouses. Data store 824 may include data associated with different networking system 820 users and/or client systems 830.

The client system 830 is generally a computer or computing device including functionality for communicating (e.g., remotely) over a computer network. The client system 830 may be a desktop computer, laptop computer, tablet computer, in- or out-of-car navigation system, smart phone or other cellular or mobile phone, or mobile gaming device, among other suitable computing devices. Client system 830 may execute one or more client applications, such as a Web browser.

When a user at a client system 830 desires to view a particular webpage (hereinafter also referred to as target structured document) hosted by the networking system 820, the user's web browser, or other document rendering engine or suitable client application, formulates and transmits a request to the networking system 820. The request generally includes a URL or other document identifier as well as metadata or other information. By way of example, the request may include information identifying the user, a timestamp identifying when the request was transmitted, and/or location information identifying a geographic location of the user's client system 830 or a logical network location of the user's client system 830.

Although the example network environment 800 described above and illustrated in FIG. 8 is described with respect to the social networking system 820a and the game networking system 820b, this disclosure encompasses any suitable network environment using any suitable systems. For example, a network environment may include online media systems, online reviewing systems, online search engines, online advertising systems, or any combination of two or more such systems.

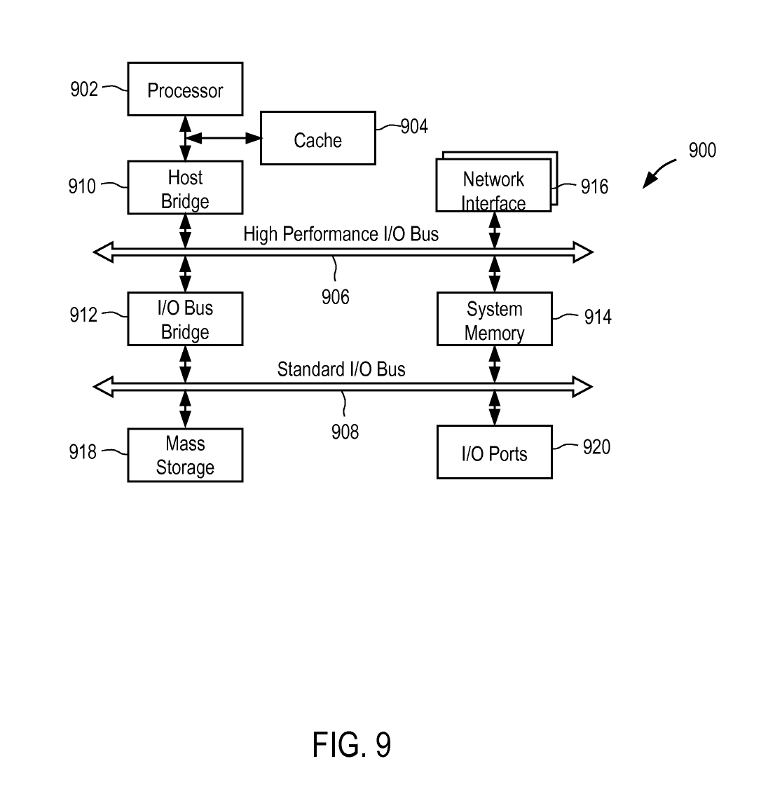

FIG. 9 illustrates an example computing system architecture, which may be used to implement a server 822 or a client system 830. In one embodiment, the hardware system 900 comprises a processor 902, a cache memory 904, and one or more executable modules and drivers, stored on a tangible computer-readable storage medium, directed to the functions described herein. Additionally, the hardware system 900 may include a high performance input/output (I/O) bus 906 and a standard I/O bus 908. A host bridge 910 may couple the processor 902 to the high performance I/O bus 906, whereas the I/O bus bridge 912 couples the two buses 906 and 908 to each other. A system memory 914 and one or more network/communication interfaces 916 may couple to the bus 906. The hardware system 900 may further include video memory (not shown) and a display device coupled to the video memory. Mass storage 918 and I/O ports 99 may couple to the bus 908. The hardware system 900 may optionally include a keyboard, a pointing device, and a display device (not shown) coupled to the bus 908. Collectively, these elements are intended to represent a broad category of computer hardware systems.

The elements of the hardware system 900 are described in greater detail below. In particular, the network interface 916 provides communication between the hardware system 900 and any of a wide range of networks, such as an Ethernet (e.g., IEEE 802.3) network, a backplane, or the like. The mass storage 918 provides permanent storage for the data and programming instructions to perform the above-described functions implemented in servers 822 of FIG. 8, whereas system memory 914 (e.g., DRAM) provides temporary storage for the data and programming instructions when executed by the processor 902. I/O ports 920 are one or more serial and/or parallel communication ports that provide communication between additional peripheral devices, which may be coupled to the hardware system 900.

The hardware system 900 may include a variety of system architectures, and various components of the hardware system 900 may be rearranged. For example, cache memory 904 may be on-chip with the processor 902. Alternatively, the cache memory 904 and the processor 902 may be packed together as a “processor module,” with processor 902 being referred to as the “processor core.” Furthermore, certain embodiments of the present disclosure may neither require nor include all of the above components. For example, the peripheral devices shown coupled to the standard I/O bus 908 may couple to the high performance I/O bus 906. In addition, in some embodiments, only a single bus may exist, with the components of the hardware system 900 being coupled to the single bus. Furthermore, the hardware system 900 may include additional components, such as additional processors, storage devices, or memories.

An operating system manages and controls the operation of the hardware system 900, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a,” “an,” or “the” is intended to mean “one or more” unless specifically indicated to the contrary. In addition, it is to be understood that functional operations, such as “awarding,” “locating,” “permitting,” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features, and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments, the term “web service” and “website” may be used interchangeably and, additionally, may refer to a custom or generalized API on a device, such as a mobile device (e.g., cellular phone, smart phone, personal GPS, PDA, personal gaming device, etc.), that makes API calls directly to a server. Still further, while the embodiments described above operate with business-related virtual objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
accessing difficulty metrics assigned to puzzle games presented within an online progression game;
selecting a cadence associated with presenting the puzzle games within the online progression game; and
using at least one processor, selectively placing the puzzle games within the online progression game based on matching the difficulty metrics to the selected cadence.

2. The method of claim 1, wherein the difficulty metrics assigned to the puzzle games presented within the online progression game are determined by an artificial intelligence game play simulator configured to play multiple instances of each of the puzzle games.

3. The method of claim 1, wherein the difficulty metrics assigned to the puzzle games presented within the online progression game are determined by an artificial intelligence game play simulator configured to play multiple instances of each of the puzzle games using a playing constraint to optimize a game play path when successfully completing each of the puzzle games.

4. The method of claim 1, wherein the difficulty metrics assigned to the puzzle games presented within the online progression game are determined by an artificial intelligence game play simulator configured to play multiple instances of each of the puzzle games using a playing constraint to optimize a game play time when successfully completing each of the puzzle games.

5. The method of claim 1, wherein the difficulty metrics assigned to the puzzle games presented within the online progression game are determined by an artificial intelligence game play simulator configured to play multiple instances of each of the puzzle games using a playing constraint to optimize a game play score when successfully completing each of the puzzle games.

6. The method of claim 1, wherein the difficulty metrics assigned to the puzzle games presented within the online progression game are determined by an artificial intelligence game play simulator configured to play multiple instances of each of the puzzle games using a playing constraint of playing each of the puzzle games as an unskilled player of the online progression game.

7. The method of claim 1, wherein the difficulty metrics assigned to the puzzle games presented within the online progression game are determined by an artificial intelligence game play simulator configured to play multiple instances of each of the puzzle games using a playing constraint of playing each of the puzzle games as a skilled player of the online progression game.

8. The method of claim 1, wherein the selected cadence is represented by a sawtooth curve; and
wherein presenting the puzzle games within the online progression game based on matching the difficulty metrics to the selected cadence includes placing the puzzle games by best fitting the difficulty metrics assigned to the puzzles to the sawtooth curve that represents the selected cadence.

9. The method of claim 1, wherein presenting the puzzle games within the online progression game based on matching the accessed difficulty metrics to the selected cadence includes:
fitting the difficulty metrics assigned to the puzzle games to a curve that represents the selected cadence;
selecting a subset of puzzle games from a set of puzzle games eligible to be placed within the online progression game by determining a best fit of the difficulty metrics to the curve that represents the selected cadence; and
placing the selected subset of puzzle games within the online progression game based on the determined best fit of the difficulty metrics to the curve that represents the selected cadence.

10. A system, comprising:
a difficulty metric module that is configured to access difficulty metrics assigned to puzzle games presented within an online progression game;
a cadence selection module that is configured to select a cadence associated with presenting the puzzle games within the online progression game; and
a processor-implemented placement module that is configured to place the puzzle games within the online progression game based on matching the accessed difficulty metrics to the selected cadence.

11. The system of claim 10, further comprising:
a player skill module that is configured to determine a skill level for a player of the online progression game;
wherein the placement module is configured to place the puzzle games within the online progression game based on matching the accessed difficulty metrics to the selected cadence and based on the determined skill level for the player of the online game.

12. The system of claim 10, wherein the difficulty module includes an artificial intelligence game play simulator configured to play multiple instances of each of the puzzle games in order to determine the difficulty metrics assigned to the puzzle games presented by the online progression game.

13. The system of claim 10, wherein the difficulty module includes an artificial intelligence game play simulator configured to play multiple instances of each of the puzzle games in order to determine the difficulty metrics assigned to the puzzle games presented by the online progression game, the played multiple instances including:
at least one instance of each of the puzzle games that is played using a constraint associated with optimizing a game play path to successfully complete each of the puzzle games;
at least one instance of each of the puzzle games that is played using a constraint associated with optimizing a game play time to successfully complete each of the puzzle games; and
at least one instance of each of the puzzle games that is played using a constraint associated with optimizing a game play score for successfully completing each of the puzzle games.

14. The system of claim 10, wherein the placement module is configured to:
fit the difficulty metrics assigned to the puzzle games to a curve that represents the selected cadence;
select a subset of puzzle games from a set of puzzle games eligible to be placed within the online progression game by determining a best fit of the difficulty metrics to the curve that represents the selected cadence; and
place the selected subset of puzzle games within the online progression game based on the determined best fit of the difficulty metrics to the curve that represents the selected cadence.

15. A computer-readable storage medium whose contents, when executed by a computing system, cause the computing system to perform operations, comprising:
performing multiple game play simulations of game challenges associated with an online progression game;
assigning difficulty metrics to the game challenges based on outcomes of the game play simulations;
accessing a curve that represents a preselected pattern associated with placing game challenges within the online progression game;
fitting the assigned difficulty metrics to the accessed curve that represents the preselected pattern;
determining an order of placement for game challenges within the online progression game based on a best fit of the assigned difficulty metrics to the accessed curve; and
generating the online progression game using the determined order of the placement of the game challenges.

16. The computer-readable storage medium of claim 15, wherein performing multiple game play simulations of game challenges associated with an online progression game includes performing the multiple game play simulations under one or more game play constraints associated with optimizing successful completion of the game challenges.

17. The computer-readable storage medium of claim 15, wherein accessing a curve that represents a preselected pattern associated with placing game challenges within the online progression game includes accessing a curve having a sawtooth shape.

18. The computer-readable storage medium of claim 15, wherein accessing a curve that represents a preselected pattern associated with placing game challenges within the online progression game includes accessing a curve having a parabolic or generally linear shape.

19. The computer-readable storage medium of claim 15, wherein assigning difficulty metrics to the game challenges based on outcomes of the game play simulations includes assigning single valued metrics to the game challenges; and
wherein fitting the assigned difficulty metrics to the accessed curve that represents the preselected pattern includes fitting the single values to a two-dimensional curve that represents the preselected pattern.

20. The computer-readable storage medium of claim 15, wherein assigning difficulty metrics to the game challenges based on outcomes of the game play simulations includes assigning vector-based metrics to the game challenges; and
wherein fitting the assigned difficulty metrics to the accessed curve that represents the preselected pattern includes fitting the single values to a three-dimensional curve that represents the preselected pattern.
